(19) United States
(12) Patent Application Publication
(10) Pub. No.: US 2010/0129179 A1
(43) Pub. Date: May 27, 2010

(54) SELF-BINDING SYSTEM

(76) Inventor: MASON PERKINS, Providence, RI (US)

Correspondence Address: MCCORMICK, PAULDING & HUBER LLP, CITY PLACE II, 185 ASYLUM STREET, HARTFORD, CT, 06103, US

(21) Appl. No.: 12/615,498

(22) Filed: Nov. 10, 2009

Related U.S. Application Data
(60) Provisional application No. 61/116,723, filed on Nov. 21, 2008.

(51) Int. Cl. B42C 99/00; B42B 5/08

(52) U.S. Cl. 412/4; 412/20; 412/19

(57) ABSTRACT

The present invention relates to a method for binding a book, said method comprising the steps of providing a bifolio with a first leaf, a second leaf, a fold edge and at least one tab protruding in a comb formation along said fold edge, providing a cover sheet with a cover sheet fold edge defining a cover page and a first page, and affixing said at least one tab to a back of said first page.

### CROSS-REFERENCE TO RELATED APPLICATIONS

This application claims the benefit of U.S. Provisional Application Ser. No. 61/116,723, filed on Nov. 21, 2008, and herein incorporated by reference in its entirety.

### FIELD OF INVENTION

The present invention relates generally to a self-binding system, and more specifically to a self-binding system for paper sheets that utilizes tabs cut into the sheets to avoid the need for conventional binding materials such as looped wire, staples, tape, thread or cloth.

### BACKGROUND OF THE INVENTION

A variety of different techniques are known for binding sheets of paper or other materials together to form books, notebooks and the like. For example, individual sheets of paper may be bound directly to the inside of the spine of a cardboard cover using a hot-melt adhesive. Sheets of paper may also be conventionally bound with various materials, such as thread, tape, wire or staples, depending upon the application. For example, most notebooks are bound with a metal, plastic, or wire binding that is inserted or looped through holes in the sheets of paper.

As another example, traditional books, especially hardcover books, are often bound using the cloth binding technique. Cloth binding involves a complex sequence of first folding and stitching sets of pages, joining these sets together with tape, glued cloth or additional stitching, and then gluing end sheets and covers. While such bindings are generally effective, they are relatively difficult to manufacture, as separate machinery may be needed for each of the different joining procedures.

Moreover, the above types of notebooks and books are made from more than one material. For example, the pages, binding and cover are typically different materials, e.g., paper, cloth, wire, staples or tape, which creates relatively high material and manufacturing costs. Significantly, notebooks that are made with a metal, plastic, or wire binding are not easily recyclable as the various pieces such as the cover, binding, and pages have to be first separated and then individually recycled.

In view of the above, a need exists for a self-binding system in which the binding and paper sheets to be bound are a single material. An additional need exists for a single material, self-binding system that may be easily recycled.

With the forgoing concerns and needs in mind, it is the general object of the present invention to provide a single material, self-binding system to reduce manufacturing and recycling costs and provide an ease of manufacture not presently known in the art.

### SUMMARY OF THE INVENTION

It is an object of the present invention to provide a self-binding system.

It is an additional object of the present invention to provide a self-binding system that reduces costs associated with the manufacture of bound paper products.

It is yet another object of the present invention to provide a self-binding system that provides an ease of manufacture presently unknown in the art.

It is another object of the present invention to provide a self-binding system that reduces the costs and difficulty associated with recycling bound paper products.

It is yet another object of the present invention to provide a self-binding system that provides a reduced cost, an ease of manufacture and reduced recycling costs through the use of a binding and paper sheets that are manufactured from a single material.

It is yet another object of the present invention to provide a self-binding system that allows for addition of sheets to the book without disassembly of the existing binding or sheets.

These and other objectives of the present invention, and their preferred embodiments, shall become clear by consideration of the specification taken as a whole.

### BRIEF DESCRIPTION OF THE DRAWINGS

FIG. 1 is an orthogonal view of the typical inner page portion of a self-binding system according to an embodiment of the present invention.

FIG. 2 is a perspective view of the typical inner page portion of the self-binding system of FIG. 1 folded to depict a series of extended tabs.

FIG. 3 is an orthogonal view of the cover and first page portion of a self-binding system according to an embodiment of the present invention.

FIG. 4 is a perspective view of the cover and first page portion of the self-binding system of FIG. 3 folded to depict the back surface.

FIG. 5 is a perspective view of an assembly of the cover and first page portion and a typical inner page portion of the self-binding system of FIGS. 2 and 4.

FIG. 6 is a perspective view of an assembly of the cover and first page portion and a typical inner page portion of the self-binding system of FIGS. 2 and 4 folded to depict the back face of the typical inner page portion.

FIG. 7 is a perspective view of an assembly of any subsequent typical page portions of the self-binding system FIGS. 2 and 6.

FIG. 8 is a perspective view of a front cover of the assembly of FIG. 7.

FIG. 9 is a perspective view of a portion of a self-binding system according to an alternative embodiment of the present invention.

FIG. 10 is an orthogonal view of a second portion of the alternative embodiment of FIG. 9.

FIG. 11 is a perspective view of an assembly of the portions of FIGS. 9 and 10.

FIG. 12 is a perspective view of a rear surface of the assembly of FIG. 11 depicting tabs folded over sheets of the inventive assembly.

FIG. 13 is an orthogonal view of a folded front cover of FIG. 12.

### DETAILED DESCRIPTION OF THE PREFERRED EMBODIMENTS

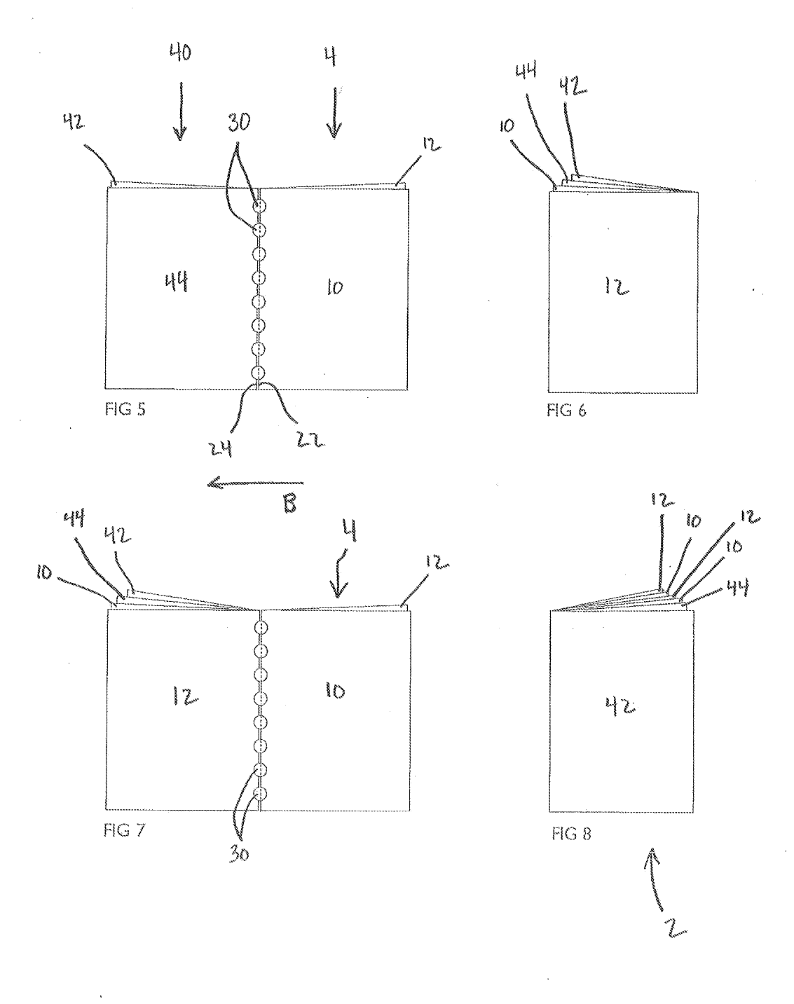

An embodiment of the inventive self-binding assembly is depicted in FIGS. 1-8. The assembly is generally comprised of a plurality of sheets that are folded in half about a fold line 20 to form two individual leaves 10, 12 meeting at a fold edge 22. This folded sheet is referred to as a bifolio. Each bifolio will constitute four pages of a book, notebook, or the like when bound. One bifolio is set aside to make a cover sheet 40, which will comprise the cover page 42 and first page 44 of a book, notebook or the like. This cover sheet 40, in unfolded and folded form, is best shown in FIGS. 3 and 4, respectively. As shown in FIG. 4, in folded form, the cover sheet 40 has a fold edge 24. Importantly, the folded cover sheet 40 does not have cut tabs along its fold edge 24 (FIG. 3) and therefore forms a blank book face (FIG. 8).

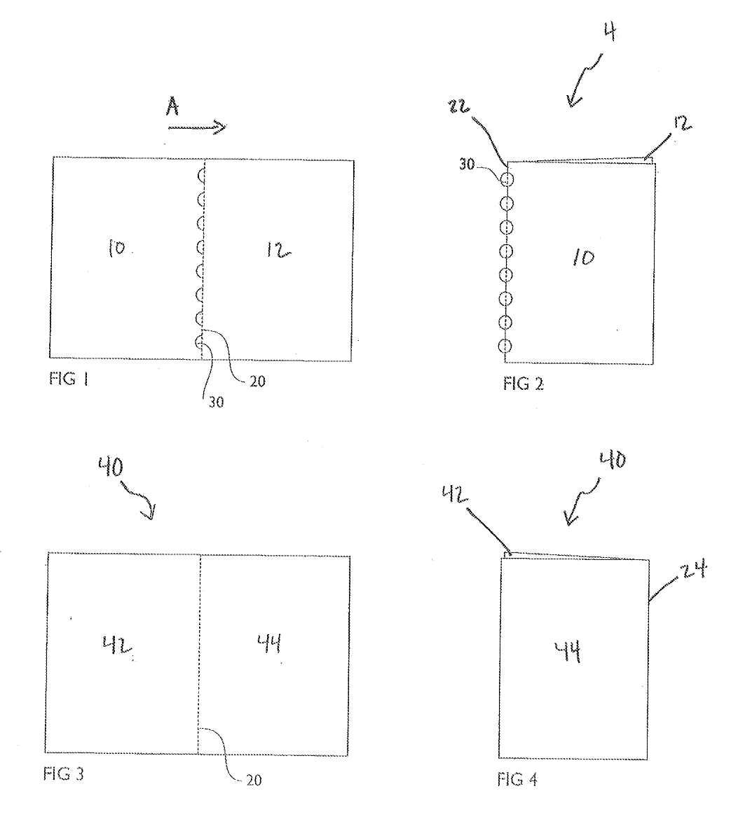

As shown in FIG. 1, the leaves 10, 12 of all of the other folded sheets are opened flat. These folded sheets are formed with at least one tab 30 and, preferably, a plurality of tabs 30 cut against the left hand side of the fold line 20. FIG. 1 shows one possible configuration of tabs 30 cut out of the left hand leaf 10 against the fold line 20. As shown in FIG. 2, when the left hand leaf 10 is folded about the fold line 20 in the direction of (A), the tabs 30 protrude in a comb formation along the fold edge 22 to form a tabbed bifolio 4. While the tabs are shown as being on the left side of the fold line 20 or fold edge 22, it will be readily appreciated that the tabs may also be formed to the right of the fold line 20 or fold edge 22. Moreover, while the tabs are shown as being semi-circular in shape, any shape tabs such as square, rectangular, ovular and the like may also be used, so long as there is sufficient surface area to effect an adhering or otherwise affixing of the tab, as described in detail below.

As shown in FIG. 5, to assemble the pages the cover sheet 40 and a tabbed bifolio 4 are placed adjacent one another so that the cover sheet fold edge 24 and fold edge 22 of the tabbed bifolio 4 face in opposing directions. In this orientation, the tabs 30 of the tabbed bifolio 4 extend past the cover sheet fold edge 24 and at least partially overlap the first page 44 of the cover sheet 40. The tabs 30 are then brought into registration with the back of the first leaf 44 and affixed thereto to form a secure binding. In the preferred embodiment, the tabs 30 are affixed to the back of the first leaf 44 by applying an adhesive, such as a glue, to either the tabs 30 or the back of the first page 44 adjacent the cover sheet fold edge 24 prior to bringing the tabs 30 and the back of the first page 44 into contact with one another. Pressing contact, heat, light or other means known in the art, depending on the type of adhesive used, will then cure the adhesive to form a secure attachment between the cover sheet 40 and tabbed bifolio 4. It will be readily appreciated, however, that any affixing means known in the art may also be used to form the binding.

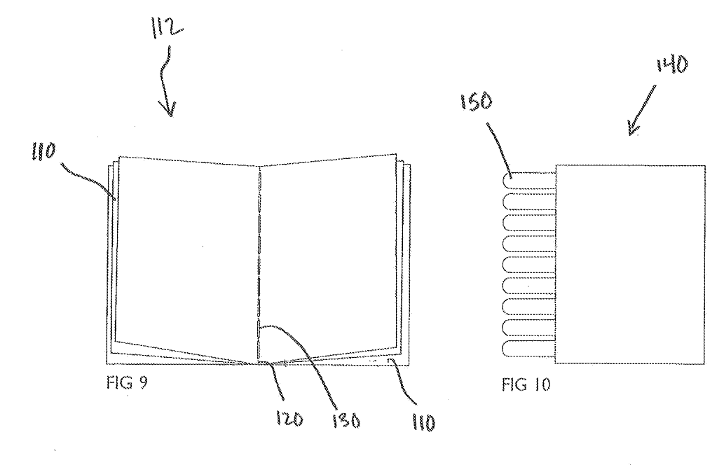

Once the tabs 30 are affixed to the first page 44 of the cover sheet 40, the tabbed bifolio 4 is then folded in the direction of (B), as shown in FIG. 5, so that the cover sheet 40 and tabbed bifolio 4 are in stacked relationship. The resulting assembly is best shown in FIG. 6. The assembly is now ready for the attachment of subsequent tabbed bifolios 4 in a manner similar to that described above. During subsequent assembly, the tabs 30 of each tabbed bifolio 4 are individually glued to the blank back of the preceding tabbed bifolio along its fold edge (FIG. 7) until a desired number of pages have been included. A finished assembly is shown in FIG. 8. As will be readily appreciated, the cover and the back page have blank faces so that the tabs, cutout portions and any adhering means are not exposed.

As shown in FIG. 8, a finished assembly 2 comprises at a cover sheet 40 having a cover sheet fold edge 24 defining a cover page 42 and a first page 44, and at least one tabbed bifolio 4 having a first leaf 10, a second leaf 12, a fold edge 22 and at least one tab 30 protruding in a comb formation along the fold edge 22, wherein the tab or tabs of the first tabbed bifolio 4 are affixed to the back of the first page 44 of the cover sheet 40. In this simple arrangement the assembly 2 will have a cover sheet (having a front and back) and six pages. As described above, additional tabbed bifolios 4 may be added to the assembly 2 to create a book, notebook or the like having as many pages as desired. As each tabbed bifolio 4 has two leaves, 10, 12 each leaf making up two pages, each subsequent tabbed bifolio 4 will add four pages to the assembly.

Preferably, each of the sheets of the assembly 2 are made of a recyclable material, although any material known in the art may be used. In the preferred embodiment the sheets are made of paper or paperboard. The fact that the binding and sheets are manufactured from a single material, i.e., from sheets of paper, is an important aspect of the present invention. The use of a single material allows for an ease of manufacture presently unknown in the art. That is, no special equipment is required to, for example, manufacture and insert a looped wire binding into stacked sheets of paper. Moreover, the use of a single material facilitates the recycling of paper or books that are bound using the method of the present invention, as a separate wire binding, for example, does not have to be removed prior to recycling as is common in the art.

As will be readily appreciated, the preferred embodiment of the inventive self-binding system is modular in that it allows for the addition of sheets to the book without disassembly of the existing binding/sheets, i.e., it is customizable. This is another important aspect of the present invention as it provides a versatility and flexibility heretofore unavailable with known bindings.

Turning now to FIGS. 9-13, an alternative embodiment of inventive self-binding assembly 100 is depicted. In this embodiment, a plurality of sheets 110 that feature a series of slots 130 about a common fold line 120 are joined together by a separate anchor sheet 140. This plurality of nested sheets 110 folded in half along a common fold line 120 is known as a “section” 112. As will be readily appreciated the last sheet in the stack of nested sheets, as shown in FIG. 9, will form the front page and the back page of the finished assembly when folded, thereby defining a front face and a back face of the assembly, respectively.

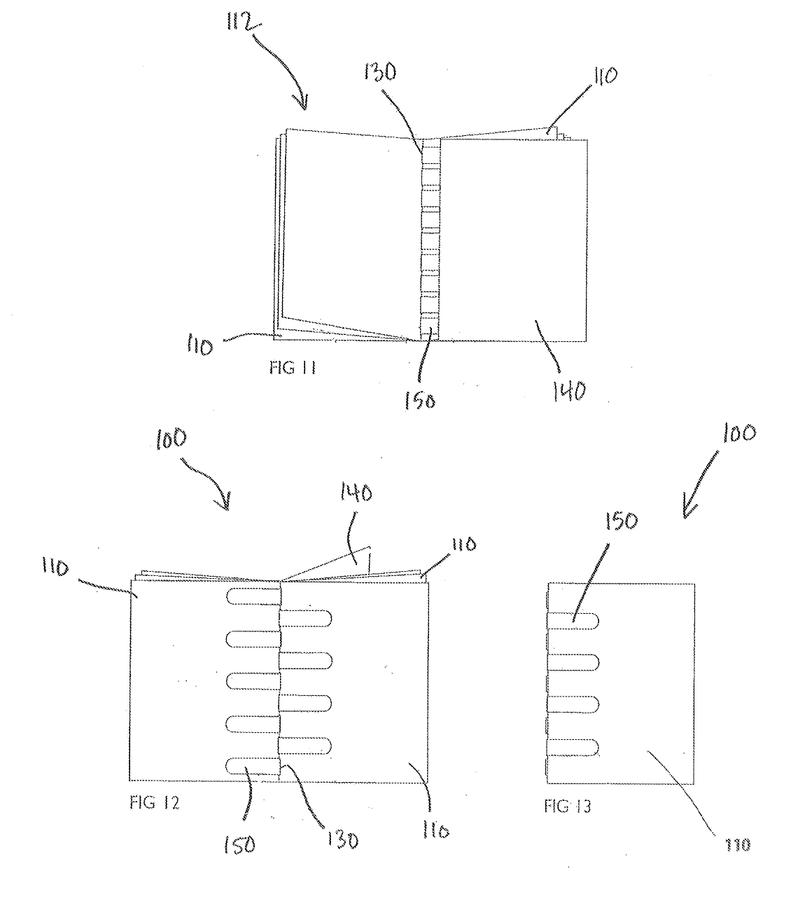

As shown in FIG. 10, the anchor sheet 140 features a plurality of tabs 150 that correspond in location and dimension to the slots 130. This allows for the tabs 150 to be inserted into the slots 130 to form the inventive binding. The insertion of the tabs 150 of the anchor sheet 140 into the complimentary slots 130 is depicted in FIG. 11. Preferably, the anchor sheet 140 is substantially the same size as an individual sheet 110 so that a uniform outer edge can be achieved.

Once the tabs 150 have been inserted into the slots 130, they are folded over and glued to the front and back faces of the outermost sheets 110 that form the front and back covers of a book bound with the inventive system. As shown, it is preferable to alternate the faces to which the tabs are glued so that no consecutive tab is glued to the same surface. This configuration creates a ladder-like arrangement on the front and back covers. As will be appreciated, the size and shape of the tabs 150 may be varied in dependence upon the quantity of sheets to be secured, i.e., longer tabs for greater numbers of sheets, and for aesthetic reasons.

With respect to aesthetics, it is noted that the tabs are visible on the front and back covers of an assembled book. As such, it may be desirable for the tabs to be colored or patterned to stand apart from or contrast with the covers. In particular, the color and shape of the tabs may be varied to market books bound with the inventive system to various consumer groups.

As will be readily appreciated, the type of books bound with the inventive system may vary. While it is envisioned that the inventive system will be used with blank note books and the like, the system may be used to bind virtually any kind of book including conventional books featuring text, illustrations and pictures.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A method for creating a book assembly, said method comprising the steps of:
providing a bifolio with a first leaf, a second leaf, a fold edge and at least one tab protruding in a comb formation along said fold edge;
providing a cover sheet with a cover sheet fold edge defining a cover page and a first page; and
affixing said at least one tab to a back of said first page.

2. The method according to claim 1, wherein the step of providing a bifolio with a first leaf, a second leaf, a fold edge and at least one tab protruding in a comb formation along said fold edge comprises:
folding a sheet of material in half along a predetermined fold line to thereby define said first leaf, said second leaf and said fold edge;
opening said sheet of material about said fold edge;
forming said at least one tab by relieving a portion of material from said first leaf or said second leaf adjacent said fold edge; and
folding said sheet of material along said fold line to thereby cause said at least one tab to protrude in a comb formation along said fold edge.

3. The method according to claim 1, wherein the step of affixing said at least one tab to a back of said first page comprises:
applying an adhesive to either said at least one tab or said back of said first page adjacent said cover sheet fold edge;
orienting said bifolio and said cover sheet so that said fold edge of said bifolio is adjacent said cover sheet fold edge and so that said at least one tab extends past said cover sheet fold edge and at least partially overlaps said first page of said cover sheet;
adhering said at least one tab to said back of said first page; and
rotating said bifolio about said fold edge to thereby bring said cover sheet and said bifolio into stacked relationship.

4. The method according to claim 1, further comprising the step of:
adhering at least one tab of another bifolio having a first leaf, a second leaf, a fold edge and at least one tab protruding in a comb formation along said fold edge to a back of a preceding bifolio.

5. The method according to claim 4, further comprising the step of:
repeating the step of adhering at least one tab of another bifolio to a back of a preceding bifolio until a desired amount of pages is achieved.

6. A page binding assembly for a book, comprising:
a cover sheet, said cover sheet having a fold edge defining a cover page and a first page;
at least one tabbed bifolio, said at least one tabbed bifolio having a first leaf, a second leaf, a fold edge and at least one tab protruding in a comb formation along said fold edge;
wherein said at least one tab is affixed to a back of said first page of said cover sheet.

7. The page binding assembly of claim 6, further comprising:
a plurality of tabbed bifolios, each tabbed bifolio being affixed to a preceding tabbed bifolio, said folded cover sheet and said plurality of tabbed bifolios being in stacked relationship.

8. The page binding assembly of claim 6, wherein said at least one tab is a plurality of tabs.

9. The page binding assembly of claim 6, wherein said at least one tab is semi-circular in shape.

10. The page binding assembly of claim 6, wherein said tabbed bifolio is made of a recyclable material.

11. A method for creating a book assembly, said method comprising the steps of:
providing a section with a front face and a rear face separated by a fold edge, and at least one slot formed through said section at said fold edge;
providing an anchor sheet with at least one tab on an inside edge thereof;
threading said at least one tab of said anchor sheet trough said at least one slot of said section; and
affixing said at least one tab to one of said front face or said rear face.

12. The method according to claim 11, wherein the step of providing a section with a front face and a rear face separated by a fold edge, and at least one slot formed through said section at said fold edge comprises:
providing a plurality of sheets of material;
folding said sheets of material in half along a predetermined fold line;
opening said sheets of material and nesting said sheets to form said section;
removing a portion of material from each of said sheets of said section along said fold line, thereby creating an aperture through said section at said fold edge to form said at least one slot.

13. The method according to claim 11, wherein said at least one slot is a plurality of slots and said at least one tab is a plurality of tabs, and wherein the step of threading comprises:
threading said plurality of tabs through said plurality of slots.

14. The method according to claim 13, wherein said step of affixing comprises:
adhering said plurality of tabs alternatively to said front face and said rear face of said section, thereby resulting in a ladder-like pattern of adhered tabs on said front face and said rear face.

15. A page binding assembly for a book, comprising:
a plurality of nested sheets of material folded in half along a fold line, said nested sheets defining a section having a front face and a rear face;
at least one slot formed through said section at said fold line; and
an anchor sheet having at least one tab on an inside edge thereof, said at least one tab being threaded through said at least one slot;
wherein said at least one tab is adhered to said front surface or said rear surface of said section to thereby bind said sheets together.

16. The page binding assembly of claim 15, wherein said at least one slot is a plurality of slots and said at least one tab is a plurality of tabs.

17. The page binding assembly of claim 16, wherein said plurality tabs are threaded through said plurality of slots at said fold line and alternately adhered to said front face and said rear face of said section.

18. The page binding assembly of claim 15, wherein said plurality of nested sheets are made of a recyclable material.

19. The page binding assembly of claim 16, wherein said plurality of slots are oblong in shape.

20. The page binding assembly of claim 19, wherein said plurality of tabs are finger-like in shape.
